(19) United States
(12) Patent Application Publication
(10) Pub. No.: US 2004/0235533 A1
(43) Pub. Date: Nov. 25, 2004

(54) Hands-free cradle and kit

(76) Inventor: Hyon S. Bae, Burlingame, CA (US)

Correspondence Address: Jacobson Holman, PLLC, The Jennifer Building, 400 Seventh Street, N.W., Washington, DC, 20004-2201, US

(21) Appl. No.: 10/442,444

(22) Filed: May 21, 2003

(51) Int. Cl. H04M 1/00; H04B 1/38

(52) U.S. Cl. 455/569.1; 455/550.1

(57) ABSTRACT

A hands-free cradle and kit for hands-free operation of a mobile phone. The mobile phone has a female-shaped communications port for passing signals. A recess shaped to receive the mobile phone is formed in the cradle casing. A male-shaped communications connector protrudes into the recess from a wall of the casing. A latch protrudes from the wall of the casing into the recess. The mobile phone has a slot situated to engage the latch when the mobile phone is received in the recess. The latch is capable of moving, while engaged with the slot in the mobile phone, from a raised position to a lowered position in which the communications connector mates with the communications port of the mobile phone. The latch is locked when moved to the lowered position. The latch can be unlocked to permit movement from the lowered position to the raised position.

### FIELD

The present invention relates generally to a cradle and a kit for receiving a mobile phone to enable hands-free operation of the mobile phone. More particularly, the present invention relates to a cradle which provides improved docking and data coupling when the mobile phone is docked in the cradle.

### BACKGROUND

A conventional hands-free cradle is capable of receiving a communications device, such as a mobile phone, so a user can operate the communications device in a hands-free manner. The cradle is often one component of a hands-free kit which includes other components to provide for hands-free use of the phone.

A hands-free cradle can be provided in an automobile. A user enters the automobile and places a mobile phone in the hands-free cradle. A headset carrying a microphone and speaker is worn by the user. The headset is coupled to a headset output of the hands-free cradle. The headset output, in turn, is coupled to a communications connector in the cradle. When the communications connector interfaces with the mobile phone, audio signals can be transmitted between the headset and mobile phone through the hands-free cradle. The user can interact with the mobile phone in a hands-free manner.

A speaker output of the hands-free cradle can be connected to an audio system in the automobile. Speaker signals ordinarily sent to the headset speaker are routed to the audio system for broadcast over speakers in the automobile. Again, when the communications connector of the hands-free cradle is connected to the mobile phone, audio signals can be transmitted between the headset and mobile phone through the hands-free cradle, enabling the user to interact with the mobile phone in a hands-free manner.

The mobile phone generally includes a communications port which provides a connection to external devices such as the hands-free cradle. The communications port generally has data input/output (I/O) connections for passing data between the mobile phone and an external communications connector. In the examples above, the communications port of the mobile phone has to be connected to the communications connector of the hands-free cradle for signals to be transmitted between the two devices.

Communications ports of mobile phones can have different shapes. In one group of phone models, such as those currently offered by Nokia and Ericsson, the communications port is essentially a row of spring-loaded pins which meets with a communications connector having a similar row of aligned pins. In a second group of phone models, such as those currently offered by Samsung, LG Electronics, and Motorola, the communications port has a female shape. The communications connector of the hands-free cradle is shaped as a male connector to interface with the female shaped communications port of these mobile phone models.

One problem with conventional hands-free cradles which receive phones with female shaped communications ports involves coupling to the communications connector when the mobile phone is received in the cradle. The communications connectors of conventional hands-free cradles are not situated to interface with the communications port of the mobile phone when a user puts the phone in the cradle. Instead, conventional cradles require that a cable be coupled to the communications port of the mobile phone so data signals can be transferred. The communications connector is the cable, having a male shape at one end and being connected to a control box at the other end. In many instances, after inserting the phone in the cradle, the user has to perform the steps of manually connecting the male-shaped end of the cable to the female-shaped communications port of the mobile phone, then connecting the other end of the cable to a communications interface in the control box.

Another problem with conventional hands-free cradles involves docking the mobile phone in the cradle. Conventional hands-free cradles do not provide lock or latch mechanisms which effectively hold the mobile phone in place when received in the hands-free cradle. Without effective locking means, the phone is not protected from external disturbances. For instance, automobiles often encounter bumps in the road, and users can bump cradles during use. If the mobile phone is not properly locked in place, the phone can become loose and fall out of the cradle, interfering with hands-free use of the phone, and possibly damaging the phone and other components.

### SUMMARY

Aspects of the present invention relate to a hands-free cradle and kit. The hands-free cradle is made to receive a mobile phone to enable hands-free operation of the mobile phone. The mobile phone has a communications port for passing signals. The communications port has a female shape.

According to one aspect of the present invention, the hands-free cradle comprises a casing in which a recess is formed. The recess is shaped to receive the mobile phone. A communications connector has a male shape and protrudes into the recess from a wall of the casing. The wall defines a boundary of the recess. The female-shaped communications port of the mobile phone is situated to meet with the communications connector when the mobile phone is received in the recess. A latch protrudes from the wall of the casing into the recess. The mobile phone has a slot situated to engage the latch when the mobile phone is received in the recess. The latch is capable of moving, while engaged with the slot in the mobile phone, from a raised position in which the phone is received to a lowered position in which the communications connector mates with the communications port of the mobile phone. A locking part is in cooperation with the latch. The locking part is engaged to restrict movement of the latch responsive to the latch moving from the raised position to the lowered position. An unlocking part is in cooperation with the locking part and the latch. The unlocking part disengages, when activated, the locking part to permit movement of the latch from the lowered position to the raised position.

According to another aspect of the present invention, the hands-free cradle includes a headset output coupled to the audio signal interface of the communications connector. A hands-free kit includes the hands-free cradle and a headset having a speaker and a microphone. The speaker and the microphone are coupled to the headset output of the hands-free cradle to pass audio signals between the headset and the mobile phone.

### BRIEF DESCRIPTION OF THE FIGURES

The detailed description below may be better understood with reference to the following figures. The figures illustratively show one or more embodiments of the invention, and are not intended to limit the scope of the claims in any way. The components in the figures are not necessarily to scale, emphasis instead being placed upon clearly illustrating principles of the present invention. In the figures, like reference numerals designate corresponding parts throughout the several views.

FIG. 1 shows a perspective view of a hands-free cradle 100 with latches in a raised position, constructed according to one embodiment of the present invention;

FIG. 2 shows a perspective view of hands-free cradle 100 with latches in a lowered position;

FIGS. 3A-3D show perspective views of hands-free cradle 100 as a mobile phone is inserted into the hands-free cradle;

FIGS. 4A-4C show perspective views of hands-free cradle 100 as the mobile phone is released from the cradle;

FIG. 5 shows a perspective rear cutaway view of hands-free cradle 100;

FIGS. 6A and 6B show opposing perspective views of a latching member of hands-free cradle 100;

FIGS. 7A-7D show perspective rear cutaway views of hands-free cradle 100;

FIG. 8A shows a rear cutaway view of a hands-free cradle 800 constructed according to another embodiment, with latches in a raised position;

FIG. 8B shows a rear cutaway view of hands-free cradle 800, with latches in a lowered position;

FIG. 8C shows a detailed rear cutaway view of an upper latch assembly 804 in the raised position;

FIG. 8D shows a detailed rear cutaway view of the upper latch assembly 804 in the lowered position;

FIGS. 9A and 9B show a headset 900 constructed according to one embodiment of the present invention; and

FIGS. 10A and 10B show a user wearing the headset 900.

### DETAILED DESCRIPTION

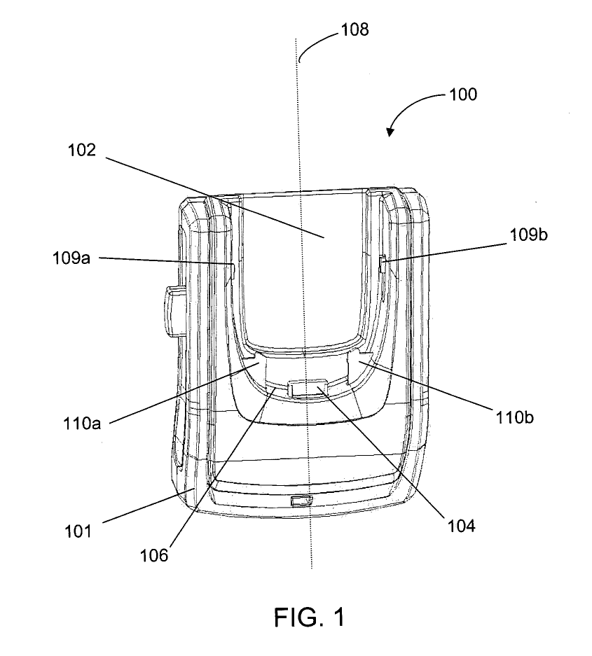

FIG. 1 shows a perspective view of a hands-free cradle 100 for receiving a mobile phone to enable hands-free operation of the mobile phone. The cradle includes a casing 101 in which a recess 102 is formed. The recess 102 is shaped to receive the mobile phone. A communications connector 104 having a male shape protrudes into the recess 102 from a wall 106 of the casing. The wall 106 of the casing 101 defines a boundary of the recess 102. The hands-free cradle 100 has a longitudinal axis 108 oriented as shown.

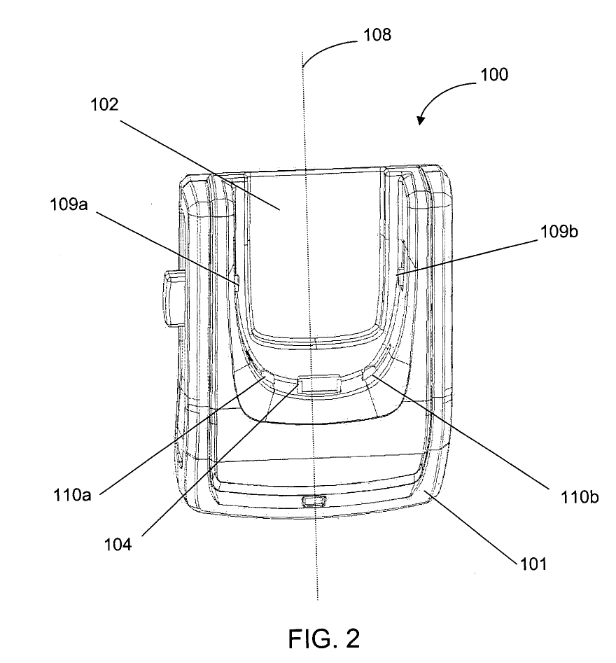

In FIG. 1, the hands-free cradle 100 has a pair of upper latches 109a, 109b and a pair of lower latches 110a, 110b. Both pairs of latches are situated on opposite sides of the communications connector 104 and protrude from the wall 106 of the casing into the recess 102. Thus, on one side of communications connector 104 is upper latch 109a and lower latch 110a. The latches 109a, 109b, 110a, 110b are capable of moving along longitudinal axis 108 when the mobile phone is received in recess 102. As explained below, when the mobile phone is received in recess 102, the latches can move from a raised position, shown in FIG. 1, along longitudinal axis 108, to a lowered position shown in FIG. 2. The latches 109a, 109b, 110a, 110b are part of a latching member described below.

FIG. 2 shows a perspective view of hands-free cradle 100 with latches 109a, 109b, 110a, 110b in a lowered position. The latches are capable of being locked in the lowered position, as explained below. The mobile phone has been removed from FIG. 2 for purposes of illustrating the latches in the lowered position. Generally, the mobile phone is received in recess 102 when the latches move from the raised to the lowered position.

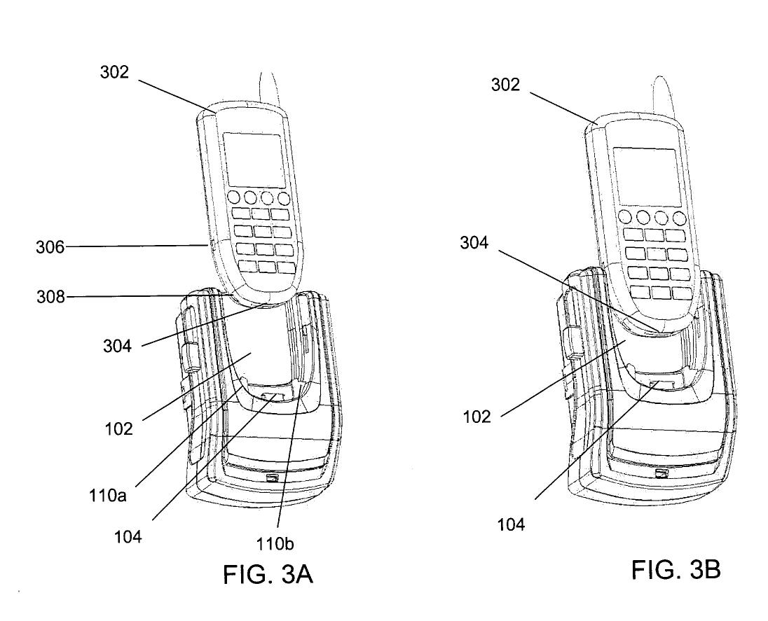

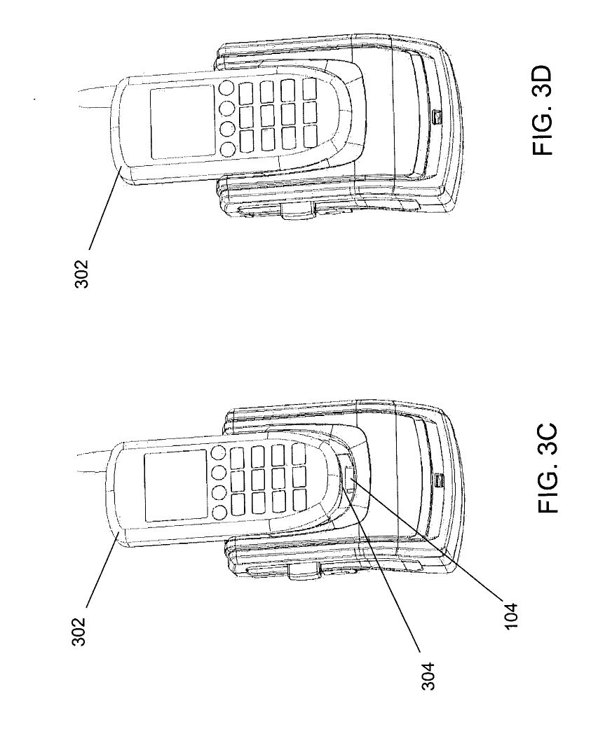

FIGS. 3A-3D show perspective views of hands-free cradle 100 as a mobile phone 302 is inserted into the cradle 100. Mobile phone 302 is any phone having a communications port which is capable of interfacing with a male communications connector, or otherwise provides for a male-female I/O connection. In one example, as shown in FIGS. 3A-3D, the mobile phone 302 has a female-shaped communications port 304 situated on a lower side of the mobile phone 302. The communications port 304 has connections for passing data signals, including audio signals such as speaker and microphone signals, and other data such as contact information, to and from the mobile phone 302. In some instances, the communications port 304 also provides connections for a power supply and ground (GND). When the communications port 304 interfaces with an external device, data signals can be passed between the external device and the mobile phone 302.

In FIGS. 3A-3C, the recess 102 of hands-free cradle 100 receives at least the part of mobile phone 302 having the communications port 304. The female-shaped communications port 304 of the mobile phone is situated to meet with the communications connector 104 of the cradle 100, as shown in FIG. 3C. In FIG. 3A, mobile phone 302 includes slots 306, 308 situated on sides of the phone 302 to receive the upper and lower latches 109a and 110a when mobile phone 302 is received in the cradle.

As shown in FIGS. 3A-3C, a user can insert mobile phone 302 into cradle 100. In FIG. 3C, the mobile phone 302 is shown as received in recess 102 of the cradle. The communications connector 104 in cradle 100 meets with the communications port 304 of the mobile phone 302. In FIGS. 3A-3C, the latches are still in the raised position.

After the mobile phone 302 is inserted in the recess 102 and the latches engage the slots in the mobile phone, as shown in FIG. 3C, the user can press on the mobile phone 302 to move the latches to the lowered position of FIGS. 2 and 3D. The phone moves with the latches so the communications connector 104 and communications port 304 mate with one another. In FIG. 3D, the latches have moved from the raised position to the lowered position. The communications connector 104 has mated with the communications port 304 of the mobile phone 302.

The communications connector 104 of hands-free cradle 100 has interfaces which are aligned to meet with the audio, data, power, ground, and possibly other connections in the communications port of mobile phone 302. In this way, when communications connector 104 mates with the communications port 304 of mobile phone 302, signals can pass between the cradle and the mobile phone.

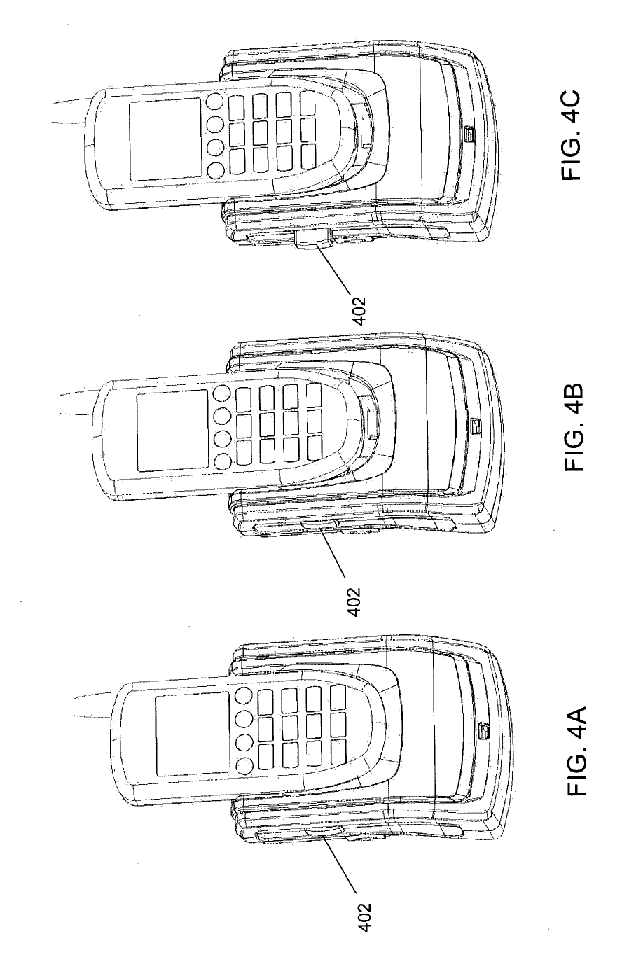

FIGS. 4A-4C show perspective views of hands-free cradle 100 as the mobile phone released from the cradle. To this end, an unlocking part of the cradle includes a button 402 mounted on a side of the cradle 100, remote from the recess 102. Alternative embodiments include buttons with various shapes, and mounted in different locations than what is shown in FIGS. 4A-4C. In another alternative embodiment, a switch is used in place of the button 402. When the button 402 or switch of the elevator unlocking part is pressed, as shown in FIGS. 4A and 4B, a locking part is released, allowing the latches to move from the lowered position of FIG. 4A to the raised position of FIGS. 4B and 4C. The unlocking and locking parts are described in greater detail below. The button 402 is preferably spring-loaded so, after the latches move to the raised position of FIG. 4C, the button again protrudes from the side of the cradle 100.

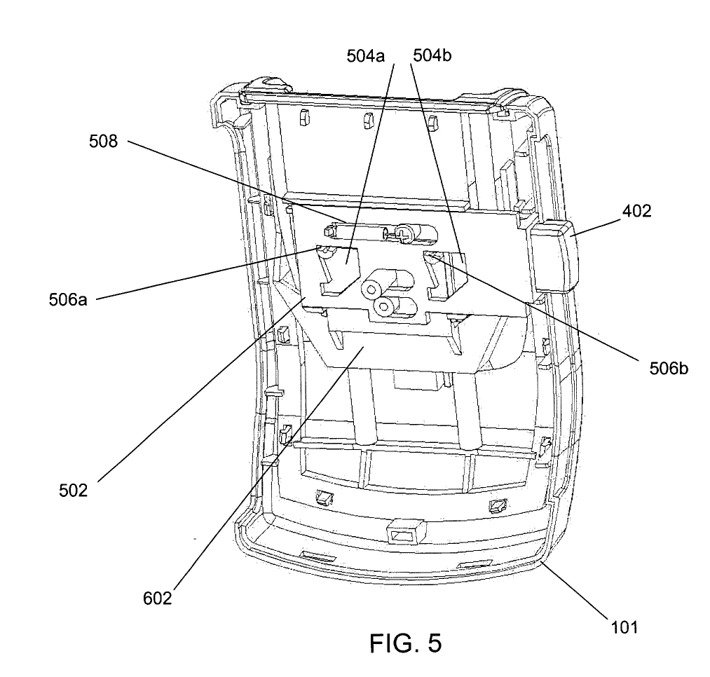

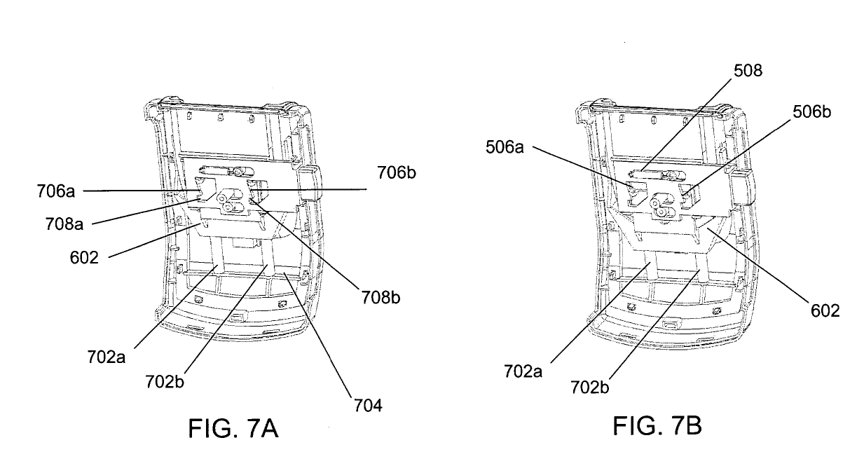

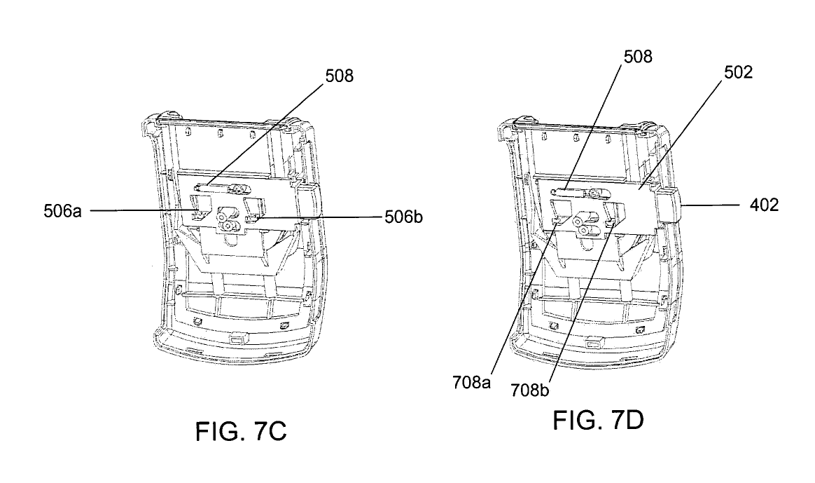

FIG. 5 shows a perspective rear cutaway view of hands-free cradle 100. In the embodiment of FIG. 5, the unlocking part and locking part are integrated in a molded piece 502 situated inside the casing 101 of cradle 100. The locking part includes a pair of notches 504a, 504b formed in molded piece 502. A pair of latch locking arms 506a, 506b extend into the notches 504a, 504b from a molded latching member 602, described below. The unlocking part includes button 402 and a spring 508 integral with the molded piece 502 as shown in FIG. 5. The operation of the locking and unlocking parts is described below with reference to FIG. 7.

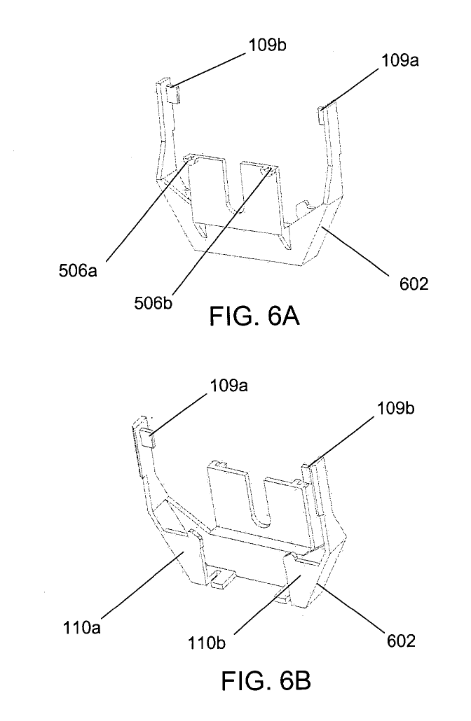

FIGS. 6A and 6B show opposing perspective views of a latching member 602 of hands-free cradle 100. In one embodiment, the latches 109a, 109b, 110a, 110b described above are attached to latching member 602 or molded as extensions of member 602 as illustrated. Latching member 602 is situated in cradle 100 as shown in FIG. 5. Thus, according to this embodiment, when the latches move from the raised position to the lowered position, the entire latching member 602 moves within the casing 101. In other alternative embodiments, the latches 109a, 109b, 110a, 110b are not joined by virtue of member 602 and move independent of one another.

FIGS. 7A-7D show perspective rear cutaway views of hands-free cradle 100 as the latches move from the raised position, in FIG. 7A, to the lowered position in FIG. 7D. Two springs 702a and 702b are seated between a fixed part 704 of casing 101 and a lower part of latching member 602 proximate lower latches 110a and 110b. The springs 702a and 702b push latching member 602 upwards along longitudinal axis 108 of FIG. 1 from the lowered position towards the raised position. Thus, the latches are generally in the raised position unless pressed downwards to the lowered position.

When the mobile phone is received in the cradle 100, and the user presses down on the mobile phone, the latching member 602 and latches move from the raised position of FIG. 7A, in the manner shown in FIGS. 7B and 7C, until the lowered position of FIG. 7D is reached. During this motion, as shown in FIGS. 7A-7D, the latch locking arms 506a, 506b move down along angled walls 706a, 706b of the notches 504a, 504b until the arms 506a, 506b are seated in retaining portions 708a, 708b of the notches. Spring 508 pulls molded piece 502 in a direction perpendicular to the longitudinal axis to assist in holding arms 506a, 506b in the seated position. When the latch locking arms are seated in this manner, movement of the latching member 602 and the latches is restricted. Thus, the locking part is engaged to lock the latches responsive to the latches moving from the raised position of FIG. 7A to the lowered position of FIG. 7D.

In FIGS. 5 and 7D, the unlocking part is activated by pressing button 402. Because button 402 is attached to molded piece 502, the pressing of button 402 causes molded piece 502 to move perpendicular to the longitudinal axis 108, so the latch locking arms 506a, 506b are released from retaining portions 708a, 708b of the notches 504a, 504b. Thus, the springs 702a, 702b force the latching member 602 and latches to move from the lowered position of FIG. 7D to the raised position of FIGS. 5 and 7A.

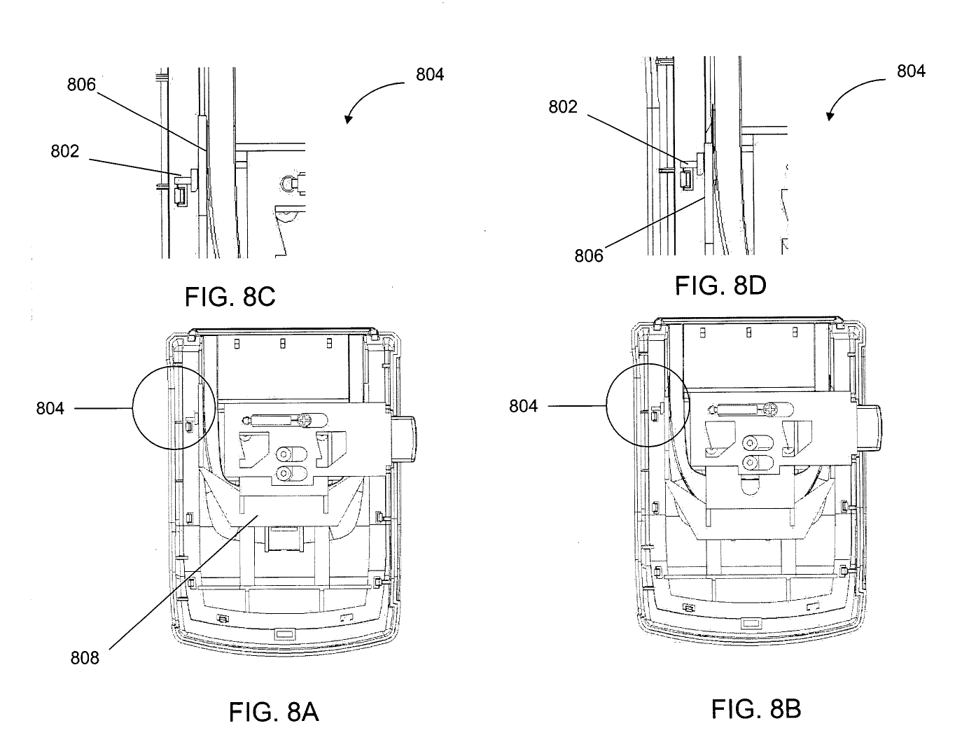

FIGS. 8A-8D show rear cutaway views of a hands-free cradle 800 constructed according to an alternative embodiment. An upper latch assembly 804 is provided. In FIG. 8C, a detailed rear cutaway view of upper latch assembly 804 in a raised position is shown. The latch assembly 804 includes upper latch 802 and a latch retaining arm 806. The upper latch 802 is spring loaded. Thus, in the raised position, the user can easily insert and remove mobile phone 302 from hands-free cradle 100.

FIG. 8D shows a detailed rear cutaway view of upper latch assembly 804 in a lowered position. The raised position and lowered position of latch assembly 804 are accomplished by the movement of latch retaining arm 806. This arm 806 is situated along one side of the interior of casing 101. The latch retaining arm 806 is attached to or molded as an extension of latching member 808, while latch 802 moves independent of latching member 808. Thus, when latching member 808 moves from the raised position of FIGS. 8A and 8C to the lowered position of FIGS. 8B and 8D, latch retaining arm 806 moves with the member 808 behind upper latch 802 as shown, thus blocking and restricting movement of spring loaded latch 802. In another embodiment, a counterpart to latch assembly 804 is situated on the opposite side of casing 101. Thus, in the lowered position, mobile phone 302 is locked into hands-free cradle 100 and cannot be removed until the latches move back to the raised position.

Components in the embodiments described above cooperate with one another to retain mobile phone 302 and lock the latches in place when the latches are in the lowered position, and release the latches to move to the raised position for removal of the mobile phone 302. Thus, the lowered position can be referred to as a “locked” position, and the raised position can be referred to as an “unlocked” position.

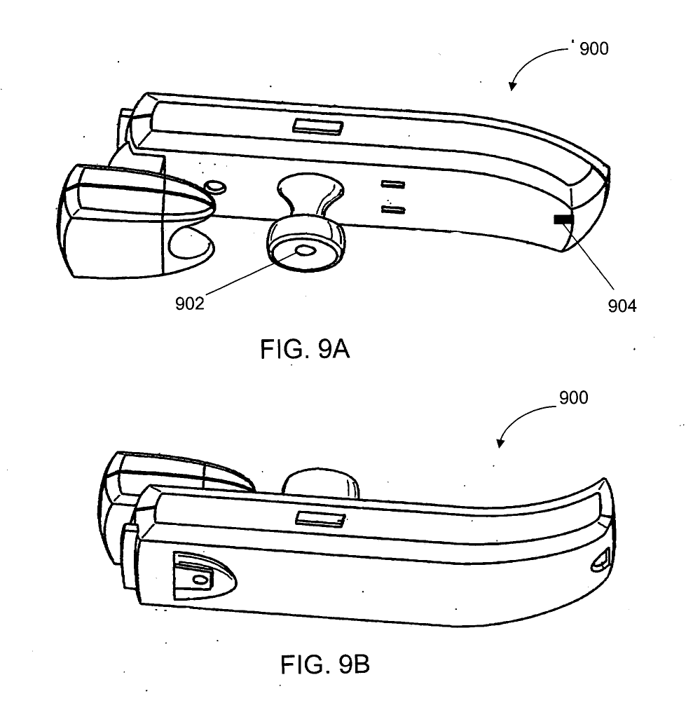

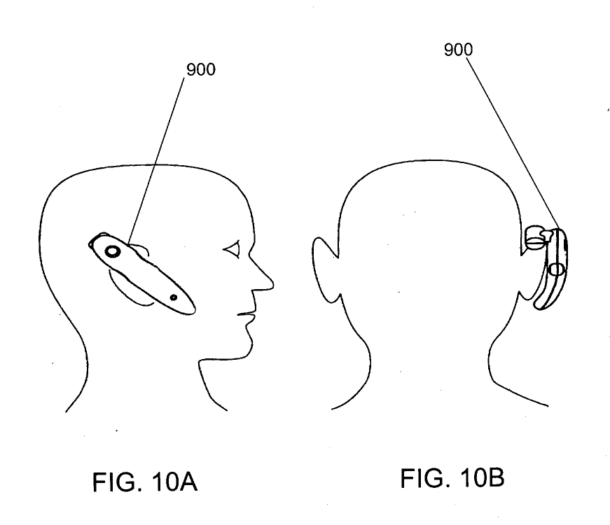

Further embodiments of the present invention relate to a hands-free kit. The hands-free kit incorporates any of the hands-free cradle embodiments described above, in addition to a headset capable of communicating with the hands-free cradle. An exemplary headset 900 is shown in FIGS. 9A and 9B. This headset is described in a U.S. Patent Application filed herewith on behalf of inventor Hyon S. Bae, titled “Headset with Retractable Battery Pack,” U.S. Application No. --/---,--- hereby incorporated by reference in its entirety. The headset has a speaker 902 and a microphone 904 built into one end of the headset 900. The speaker 902 and microphone 904 are in communication with a headset output or interface of the hands-free cradle. In this way, audio signals can pass between the headset 900 and the mobile phone when the mobile phone is docked in the hands-free cradle. The headset 900 can be worn by a user in the manner shown in FIGS. 10A and 10B.

Various headsets can be used in and with embodiments of the hands-free cradle and kit of the present invention. Examples of suitable headsets include, in addition to the headset described above, conventional ear bud headsets, on-the-ear headsets and over-the-head headsets. The ear bud headset has a speaker encased in a casing that is designed to be positioned in the opening of the user's ear. The ear bud headset includes an earpiece which extends around the perimeter of the user's ear. The-on-the-ear headset has a speaker which rests on the exterior of the ear, and is generally held against the ear by an earpiece which extends from the speaker and wraps around the perimeter of the user's ear. Over-the-head headsets use speakers that rest on the ear and have a headband extending there from that wraps at least partially over the user's head. Other headsets suitable for use in and with hands-free cradle and kit embodiments of the present invention include modular headsets with various mounting arrangements such as snap-on and screw-on configurations.

Headsets suitable for use in and with embodiments of the present invention include both wireless and wired models. When a wireless application is desired, the headset includes, in addition to the speaker and microphone, a battery pack and transceiver. The battery pack and transceiver can be incorporated into the headset in various ways. Those skilled in the art will appreciate that a hands-free kit made in accordance with embodiments of the present invention also generally includes a power adapter. The power adapter has a power source interface which connects to a power source, such as the cigarette lighter of an automobile, and also has a cradle interface which connects to the hands-free cradle to supply power to the hands-free cradle and mobile phone through the communications connector of the cradle.

It should be emphasized that the above-described embodiments of the invention provide examples for a clear understanding of the principles of the invention. Variations and modifications can be made to the above-described embodiments without departing from the spirit and principles of the invention, as will be understood to those skilled in the art. All such modifications and variations are intended to be included within the scope of the invention and protected by the following claims.

What is claimed is:

1. A hands-free cradle for receiving a mobile phone to enable hands-free operation of the mobile phone, the mobile phone having a communications port for passing signals, the communications port having a female shape, the hands-free cradle comprising:
a casing in which a recess is formed, the recess shaped to receive the mobile phone;
a communications connector having a male shape and protruding into the recess from a wall of the casing, the wall defining a boundary of the recess, the female-shaped communications port of the mobile phone situated to meet with the communications connector when the mobile phone is received in the recess;
a latch protruding from the wall of the casing into the recess, the mobile phone having a slot situated to engage the latch when the mobile phone is received in the recess, the latch capable of moving, while engaged with the slot in the mobile phone, from a raised position in which the phone is received to a lowered position in which the communications connector mates with the communications port of the mobile phone;
a locking part in cooperation with the latch, the locking part being engaged to restrict movement of the latch responsive to the latch moving from the raised position to the lowered position; and
an unlocking part in cooperation with the locking part and the latch, the unlocking part disengaging, when activated, the locking part to permit movement of the latch from the lowered position to the raised position.

2. The hands-free cradle of claim 1, the communications connector including an audio interface.

3. The hands-free cradle of claim 1, the communications connector including a data interface.

4. The hands-free cradle of claim 1, the communications connector including a power interface.

5. The hands-free cradle of claim 1, the unlocking part including a button mounted on the casing, the unlocking part being activated responsive to the button being pressed.

6. The hands-free cradle of claim 5, the button being mounted on a side of the casing.

7. The hands-free cradle of claim 5, the button being remotely located from the recess formed in the casing.

8. The hands-free cradle of claim 5, the button protruding from the casing.

9. The hands-free cradle of claim 1, the unlocking part including a switch mounted on the casing, the unlocking part being activated responsive to the switch being pressed.

10. A hands-free cradle for receiving a mobile phone to enable hands-free operation of the mobile phone, the mobile phone having a communications port for passing signals, the communications port having a female shape, the hands-free cradle comprising:
a casing in which a recess is formed, the recess shaped to receive the mobile phone;
a communications connector having a male shape and protruding into the recess from a wall of the casing, the wall defining a boundary of the recess, the female-shaped communications port of the mobile phone situated to meet with the communications connector when the mobile phone is received in the recess;
a pair of latches protruding from the wall of the casing into the recess, the latches being spring loaded, the mobile phone having a pair of slots situated to engage the latches when the mobile phone is received in the recess, the latches capable of moving when pressed upon, while engaged with the slots of the mobile phone, from a raised position in which the phone is received to a lowered position in which the communications connector mates with the communications port of the mobile phone to pass signals to and from the mobile phone;
a locking part in cooperation with the latches, the locking part being engaged to restrict movement of the latches responsive to the latches moving from the raised position to the lowered position; and
an unlocking part in cooperation with the locking part and the latches, the unlocking part including a button mounted on the casing, the unlocking part disengaging, responsive to the button being pressed, the locking part to permit movement of the latches so that the latches can move from the lowered position to the raised position.

11. The hands-free cradle of claim 10, wherein the latches are situated on opposite sides of the communications connector.

12. The hands-free cradle of claim 10, wherein the latches are situated on one side of the communications connector.

13. The hands-free cradle of claim 10, the communications connector including an audio interface.

14. The hands-free cradle of claim 10, the communications connector including a data interface.

15. The hands-free cradle of claim 10, the communications connector including a power interface.

16. The hands-free cradle of claim 10, the button being mounted on a side of the casing.

17. The hands-free cradle of claim 10, the button being remotely located from the recess formed in the casing.

18. A hands-free kit for receiving a mobile phone and providing an audio interface with the mobile phone to enable operation of the mobile phone in a hands-free manner, the mobile phone having a communications port for passing signals, the communications port having a female shape, the hands-free kit comprising:
a hands-free cradle including:
a casing in which a recess is formed, the recess shaped to receive the mobile phone,
a communications connector having a male shape and protruding into the recess from a wall of the casing, the wall defining a boundary of the recess, the female-shaped communications port of the mobile phone situated to meet with the communications connector when the mobile phone is received in the recess, the communications connector and the communications port each having an audio signal interface,
a latch protruding from the wall of the casing into the recess, the latch being spring loaded, the mobile phone having a slot situated to engage the latch when the mobile phone is received in the recess, the latch capable of moving when pressed upon, while engaged with the slot of the mobile phone, from a raised position in which the phone is received to a lowered position in which the is communications connector mates with the communications port of the mobile phone, the respective audio signal interfaces coupling to pass audio signals to and from the mobile phone,
a locking part in cooperation with the latch, the locking part being engaged to restrict movement of the latch responsive to the latch moving from the raised position to the lowered position,
an unlocking part in cooperation with the locking part and the latch, the unlocking part including a button mounted on the casing, the unlocking part disengaging, responsive to the button being pressed, the locking part to permit movement of the latch such that the latch moves from the lowered position to the raised position, and
a headset output coupled to the audio signal interface of the communications connector; and
a headset having a speaker and a microphone, the speaker and the microphone coupled to the headset output of the hands-free cradle to pass audio signals between the headset and the mobile phone.

19. The hands-free kit of claim 18 further comprising a power adaptor having a power source interface and a cradle interface, the power adaptor capable of supplying power to the hands-free cradle through the cradle interface.

20. The hands-free kit of claim 18, the communications connector including an audio interface.

21. The hands-free kit of claim 20, the audio interface including a speaker interface.

22. The hands-free kit of claim 20, the audio interface including a communications connector.

23. The hands-free kit of claim 18, the communications connector including a data interface.

24. The hands-free kit of claim 18, the communications connector including a power interface.

25. The hands-free kit of claim 18, the button protruding from the casing.

26. The hands-free kit of claim 18, the button being remotely located from the recess formed in the casing.
